(19) United States
(12) Patent Application Publication
(10) Pub. No.: US 2010/0262990 A1
(43) Pub. Date: Oct. 14, 2010

(54) TELEVISION RECEIVER

(76) Inventor: Yusuke Nishida, Daito-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/759,269

(22) Filed: Apr. 13, 2010

(30) Foreign Application Priority Data
Apr. 14, 2009 (JP) 2009-098419

(51) Int. Cl. H04N 5/445; H04N 7/16

(52) U.S. Cl. 725/28; 725/40

(57) ABSTRACT

A television receiver comprises a separation unit which separates broadcast signals into an audio/video data, a program information, and a parental level data. The television receiver further comprises an audio/video signal processor, an audio/video output unit, a program related data decoder which decodes the program information and the parental level data, a rating data input unit to which a rating data for each user is inputted, a memory which stores the rating data, a user recognition unit which recognizes the user, and a microprocessor. The microprocessor performs a parental restriction of a program which is subject to the parental restriction and a display restriction of the program which is subject to the parental restriction in the EPG in accordance with the parental level data decoded by the program related data decoder and the rating data of the user recognized by the user recognition unit.

### BACKGROUND OF THE INVENTION

1. Field of the Invention

The present invention relates to a television receiver which performs parental lock.

2. Description of the Related Art

Conventionally, various viewing restrictions, which are called parental lock (parental restriction), are performed on TV (television) broadcastings to prevent children from watching programs with violent content and adult programs. For example, in North America (the United States and Canada), a parental level data is added in television broadcast signals (abbreviated as the broadcast signals hereinafter) to indicate a parental level relating to a necessity of restricting a viewing per program under control of V-chip. A restriction according to an age of a user which MPAA (Motion Picture Association of America) applies, and a restriction according to a content in a program in addition to the age of the user which TV Parental Guidelines applies, for example, are included in systems of the parental restrictions. The TV receiver which receives the broadcast signals having the parental level data can set the parental level for watching the program, and the program is subject to the parental restriction in accordance with the parental level set by the TV receiver. The parental level is set in accordance with the user, and in the present specification, the parental level set by the TV receiver is referred to as “rating”.

In digital broadcasting, broadcasting stations broadcast program information including a title of each program in each channel and an outline of the program in addition to the program itself, and upon receiving the program information, the TV receiver makes EPG (Electronic Program Guide) in accordance with the program information and displays the EPG on a screen. The EPG enables a user to watch the program and also enables a programmed recording when the user selects the program in the EPG, so that the program can be easily selected even when there are a number of programs to be broadcasted.

However, the EPG also displays program information of a program which is subject to a parental control of V-chip. Specifically, the EPG displays an outline of the program as well as a title of the program. In the United States, from the fact that there is a restriction of language in the TV Parental Guidelines, the parental lock of a written language is treated as important, so that it is unfavorable for children to watch the displayed title or outline of the program which is subject to the parental restriction without regulating harmful information provided by the written words.

There is a known TV receiver which displays a field of a program which is subject to the parental restriction in a pale color in the EPG to give caution (refer to Japanese Laid-Open Patent Publication No. 2006-166263, for example). However, only one rating can be set in such a TV receiver, so that the rating cannot easily be changed in accordance with the viewer (user), and moreover, the field of the program which is subject to the parental restriction is displayed merely in the pale color in the EPG, so that also the children can watch the program information of the parental restricted program. It is unfavorable.

### SUMMARY OF THE INVENTION

The present invention is to solve the problem described above, and an object of the present invention is to provide a television receiver which can restrict a display of harmful information provided by written words in a program information displayed in EPG (Electronic Program Guide) in accordance with a viewer (user).

According to an aspect of the present invention, this object is achieved by a television receiver which receives television broadcast signals including a program information indicating contents of a program and a parental level data indicating a parental restriction together with an audio/video data to display Electronic Program Guide, comprising: a receiving means which receives the television broadcast signals; a separating means which separates the television broadcast signals received by the receiving means into the audio/video data, the program information, and the parental level data; an audio/video decoder which decodes the audio/video data separated by the separating means; an audio/video signal processing means which processes audio/video signals decoded by the audio/video decoder; an audio/video outputting means which outputs audio and video based on the audio/video signals processed by the audio/video signal processing means; a program related data decoder which decodes the program information and the parental level data separated by the separating means; a rating data inputting means which inputs a rating data for each user; a storage means which stores a rating data inputted by the rating data inputting means; a user recognition means which recognizes a user watching the video and listening to the audio outputted by the audio/video outputting means; and a microprocessor which controls respective units in the television receiver.

The microprocessor performs a parental restriction of a program which is subject to the parental restriction and a display restriction of the program which is subject to the parental restriction in the EPG in accordance with the parental level data decoded by the program related data decoder and the rating data of the user recognized by the user recognition means.

According to the above configuration, the television receiver can store the rating data of each user and also recognize the user, so that the television receiver can restrict the display of the program which is subject to the parental restriction in the EPG in accordance with the user. Consequently, it is possible to restrict harmful information provided by written words not to be shown in the EPG in accordance with the user.

The user recognition means may recognize the user by fingerprint recognition. Consequently, it is possible to restrict the display of the harmful information provided by written words in the EPG more reliably and easily.

### BRIEF DESCRIPTION OF THE DRAWINGS

The present invention will be described below with reference to the annexed drawings. It is to be noted that all the drawings are shown for the purpose of illustrating the technical concept of the present invention or embodiments thereof, wherein:

FIG. 1 is a diagram of a television receiver according to a first embodiment of the present invention;

FIG. 2 is a table of a user information which a memory stores in the television receiver in FIG. 1;

FIG. 3 is a processing flow chart when the user watches a program in the television receiver in FIG. 1;

FIG. 4 is a processing flow chart when EPG is displayed in the television receiver in FIG. 1;

FIG. 5A is a diagram showing the EPG when there is no parental restriction in the television receiver in FIG. 1; and

FIG. 5B is a diagram showing the EPG when there is some parental restriction in the television receiver in FIG. 1.

### DESCRIPTION OF THE PREFERRED EMBODIMENTS

### First Preferred Embodiment

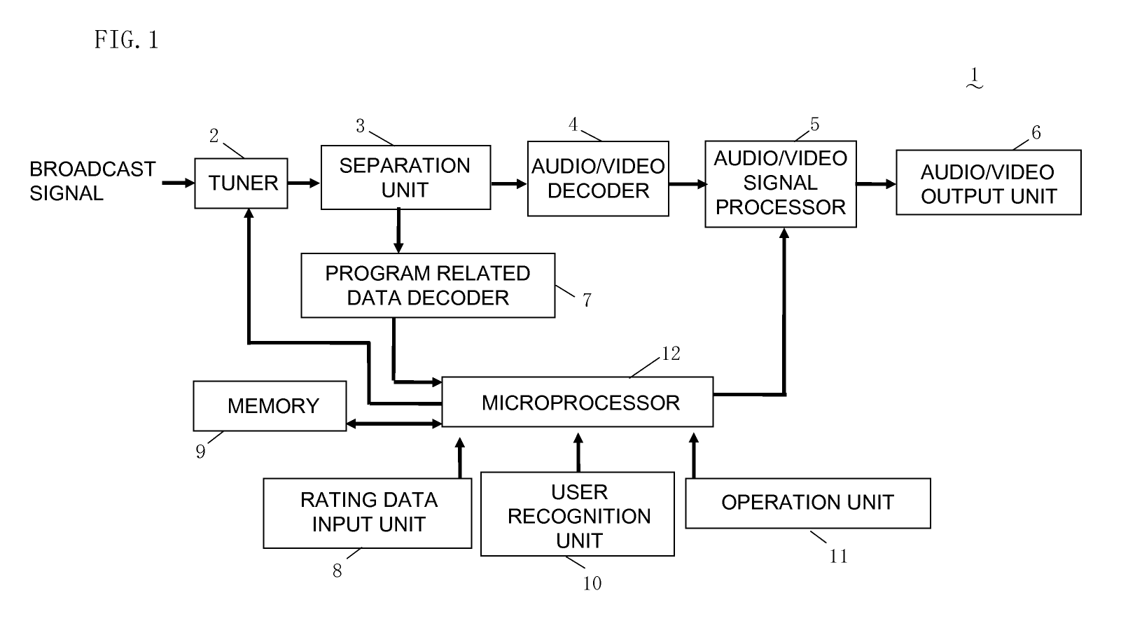

A television receiver (abbreviated as the TV receiver hereinafter) according to the first preferred embodiment of the present invention is described with reference to FIG. 1. A TV receiver 1 receives broadcast signals which include a program information indicating a title of a program and so on and a parental level data indicating a parental restriction such as an age restriction for inhibiting the viewing together with an audio/video data. Based on the broadcast signals, the TV receiver 1 performs the display restriction of the EPG (Electronic Program Guide) and the parental restriction of the program, as well as outputting the audio and video of the program. In the present preferred embodiment, the parental lock system in MPAA (Motion Picture Association of America) is applied, however, other parental lock system including the system in TV Parental Guidelines is also applicable.

The TV receiver 1 includes a tuner (receiving means) 2 which receives the broadcast signals, a separation unit (separating means) 3 which separates data contained in the broadcast signals into an audio/video data, a program information, and a parental level data, an audio/video decoder (audio/video decoding means) 4 which decodes the separated audio/video data, an audio/video signal processor (audio/video signal processing means) 5 which processes decoded signals, and an audio/video output unit (audio/video outputting means) 6 which outputs an audio and video by using the processed audio/video signals. The TV receiver 1 also includes a program related data decoder (program related data decoding means) 7 which decodes the program information and the parental level data separated by the separation unit 3; a rating data input unit (rating data inputting means) 8 to which a rating data for each user is inputted, a memory (storage means) 9 which stores the inputted rating data and so on, a user recognition unit (user recognition means) 10 which recognizes a user watching the video and listening to the audio outputted by the audio/video output unit, an operation unit 11 which is operated by the user to adjust the audio and video, and a microprocessor 12 which controls respective units in the TV receiver.

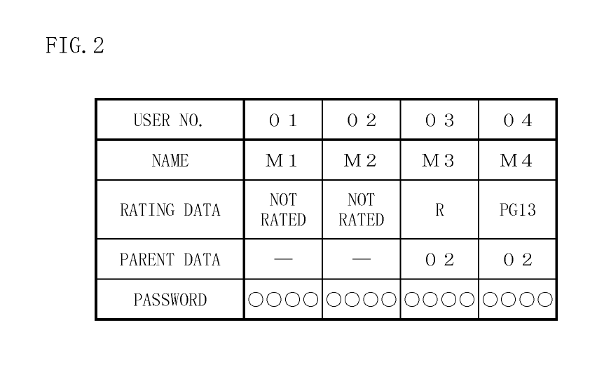

The audio/video output unit 6 has a screen (not shown) such as a liquid crystal display and a plasma display and a speaker (not shown). The rating data input unit 8 has input keys (not shown) so that a user information including a rating data of each user is inputted in advance, for example. FIG. 2 shows contents of the user information which includes a name, the rating data, a parent data, and a password. The user information may include other information. The name is not always necessary, but an abbreviated name is also applicable. In the rating data, a rating set up for each user is inputted.

The ratings of MPAA are as follows in decreasing order of severity of restriction:

N/A: Not applicable.

G: G rated.

PG: Not applicable for children. Parental guidance is suggested.

PG13: Not applicable for children under 13 years of age. Parental guidance is suggested.

R: Children under 17 years of age must be accompanied by a parent.

NC-17: No one 17 years of age and under is admitted.

X: No one under 17 years of age is admitted.

Not Rated: No restriction.

When the rating data of the user is R, for example, programs whose parental level data are R, NC-17, or X are subject to the parental restriction.

The parent data is data of a user No. which indicates a parent of the user. The parent data is necessary when the user is under 17 years of age. When the child under 17 watches the program, which is subject to the parental restriction of the child under 17 watching alone but is not restricted in case of being accompanied by the parent, the parent data is used to determine whether there is the parent of the child among the users who watch the program. The password is allocated to each user. When the system of the parental restriction of the broadcast signals which are received by the TV receiver 1 is based on TV Parental Guidelines, an additional restriction such as Violence, for example, is set up for each user as the user data. Moreover, in case of another system of parental restriction, a restriction corresponding to each system is set up.

The memory 9 stores the program information, the parental level data and the rating data, and so on. The user recognition unit 10 has input keys (not shown). The user inputs his/her own password by using the input keys when watching the TV receiver 1. The microprocessor 12 recognizes the user based on the password. When the password is not inputted, no audio and video of the program which has some restriction in the parental level data is outputted. The operation unit 11, which has plural buttons (not shown) to turn power on/off, select a channel, adjust the audio and video, and so on, is operated by the user. The operation unit 11 also has a display switch (not shown) to send a command to display the EPG and input keys (not shown) to designate a target channel and time slot for being displayed in the EPG. The rating data input unit 8, the user recognition unit 10, and operation unit 11 can also be installed on the TV receiver 1 itself or a remote controller.

The microprocessor 12 controls the audio/video signal processor 5, the tuner 2, and so on in accordance with the operation performed on the operation unit 11 to adjust the audio and video and select the channel. Upon receiving the command to display the EPG from the operation unit 11, the microprocessor 12 makes the EPG of designated channel and time slot based on the program information recorded in the memory 9 and displays the EPG on the screen of the audio/video output unit 6. Moreover, the microprocessor 12 restricts the output of the audio and video of the program and EPG display in accordance with the parental level data and the rating data, so that it does not output the audio and video of the program which is subject to the parental restriction and also does not display the program information of the parental restricted program in the EPG

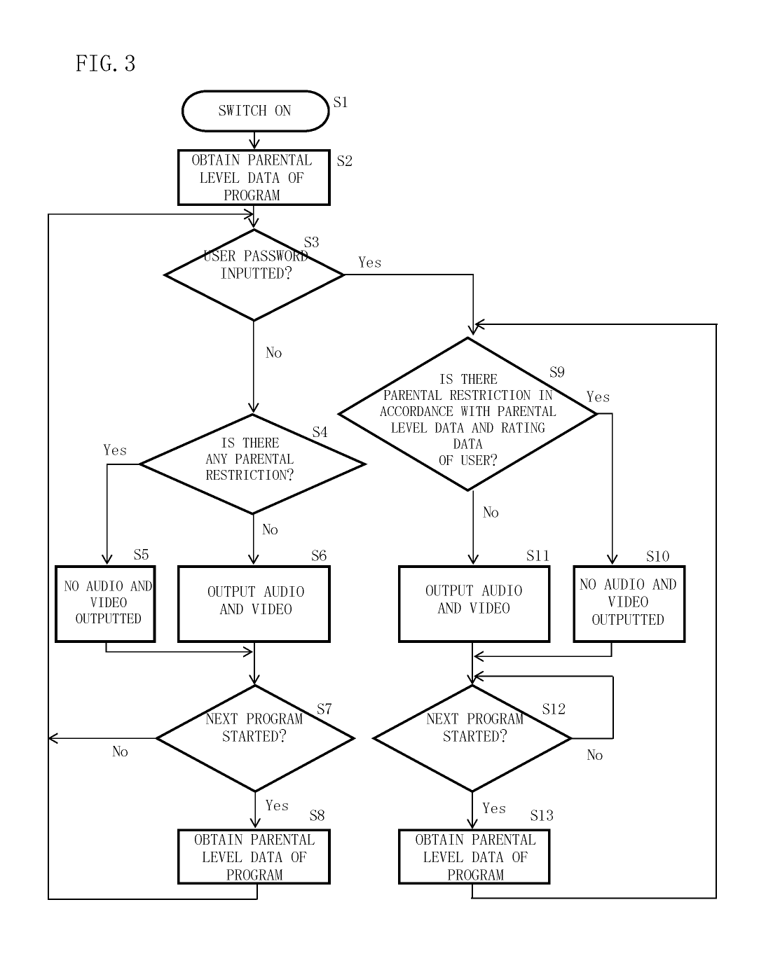

Subsequently, a processing of the TV receiver 1 is described. FIG. 3 shows a flow of the processing of the TV receiver 1 when the user watches the program. When the power is turned on (step 1, abbreviated as S1 hereinafter, the same is applied hereinafter), the microprocessor 12 firstly obtains the program information and the parental level data from the broadcast signals through the program related data decoder 7, then makes the memory 9 store the program information and parental level data, and subsequently obtains the parental level data of the selected program from the memory 9 (S2). Then, the microprocessor 12 determines whether the password of the user is inputted or not (S3). When the password is not inputted, the microprocessor 12 determines whether there is any restriction in the parental level data of the selected program (S4). When there is some restriction, the microprocessor 12 does not output the audio and video of the program (S5), and when there is no restriction, the microprocessor 12 outputs the audio and video of the program (S6). Subsequently, the microprocessor 12 determines whether the next program is started or not due to a change of channels or a passing of time (S7). When the next program is not started, the microprocessor 12 returns to the S3 and repeats the steps from the S3 to the S7. When the next program is started in the S7, the microprocessor 12 obtains the parental level data of the next program from the memory 9 (S8), returns to the S3, repeats the steps from the S3 to 7.

When the password is inputted in the S3, the microprocessor 12 recognizes the user based on the password and determines whether the selected program is subject to the parental restriction in accordance with the parental level data of the program and the rating data of the recognized user (S9). At this time, when there are the plural users who watch the program, the microprocessor 12 makes a determination in accordance with the severest rating data among the users. Moreover, when the parental level data restricts the child watching the program alone but does not restrict the child watching the program in case of being accompanied with the parent, the microprocessor 12 determines whether the parent corresponding to the parent data (see FIG. 2) in the rating data of the child watches the program together or not and then restricts the child watching the program. When there is the parental restriction, the microprocessor 12 does not output the audio and video of the program (S10), and when there is no parental restriction, the microprocessor 12 outputs the audio and video of the program (S11). Subsequently, the microprocessor 12 determines whether the next program is started or not due to a change of channels or a passing of time (S12). When the next program is started, the microprocessor 12 makes the memory 9 store the parental level data of the new program and then obtains the parental level data from the memory 9 (S13), and subsequently, returns to the S9 and restricts the user watching the program with using the new parental level data in the same manner as the previously described S9 to S12. When the next program is not started in the S12, the microprocessor 12 waits until the next program is started.

The audio and video of the program are not outputted in the S5 and S10, however, a message can be displayed on the screen in the S5 and S10 to inform of a fact that the audio and video are not outputted in accordance with the parental level data to avoid the user misunderstanding that the TV receiver 1 is in failure.

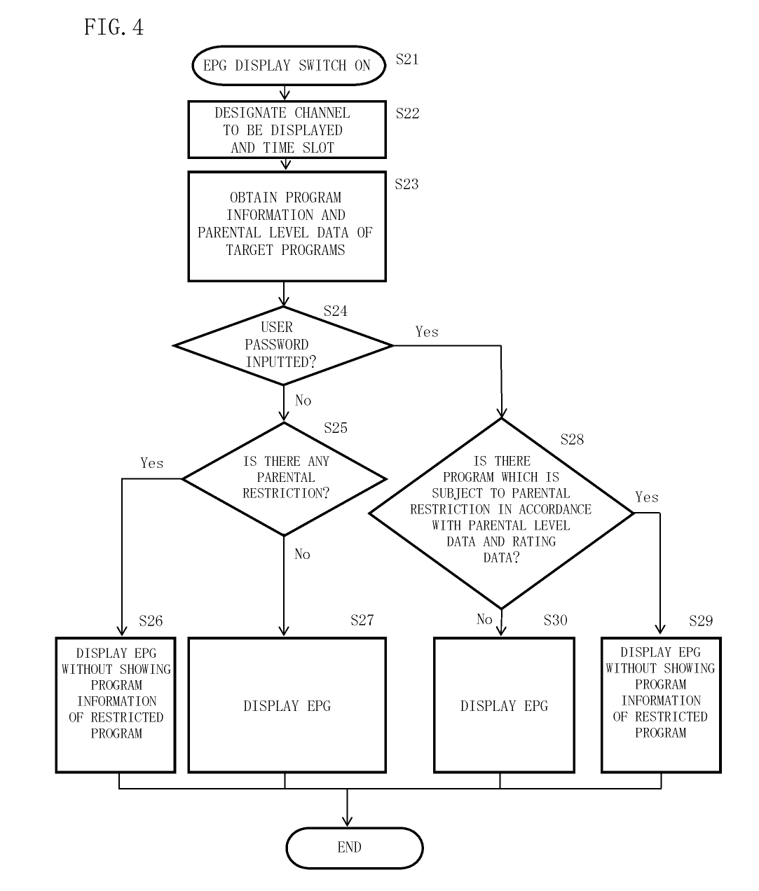

Subsequently, a processing flow of displaying the EPG is described with reference to FIG. 4. When the display switch for the EPG in the operation unit 11 is turned on (S21) and when the channel to be displayed and the time slot are designated (S22), the microprocessor 12 obtains the program information and the parental level data of the target programs for being displayed in the EPG from the memory 9 (S23). Then, the microprocessor 12 determines whether the password of the user is inputted or not (S24). When the password is not inputted, the microprocessor 12 determines whether there is any restriction in the parental level data of the target programs for being displayed in the EPG (S25). When there is some restriction, the microprocessor 12 makes the EPG based on the program information and displays the EPG without showing the program information of the restricted program(s) by turning the field(s) of the program(s) gray, for example (S26). When there is no restricted program, the microprocessor 12 makes the EPG based on the program information and displays the EPG as it is (S27).

When the password is inputted in the S24, the microprocessor 12 determines whether there is any program which is subject to the parental restriction in accordance with the parental level data of the target program for being displayed in the EPG and the rating data of the user(s) watching the program (S28). At this time, in case that there are the plural users who watch the program, the microprocessor 12 makes a determination in accordance with the severest rating data among the rating data of the users. Moreover, when the parental level data restricts the child watching the program alone but does not restrict the child watching the program in case of being accompanied with the parent, the program is subject to the parental restriction when the parent corresponding to the parent data in the rating data of the child does not watch the program. When there is some program which is subject to the parental restriction, the microprocessor 12 makes the EPG based on the program information and displays the EPG without showing the program information of the restricted program by turning the field of the program gray, for example (S29). When there is no restricted program, the microprocessor 12 makes the EPG based on the program information and displays the EPG as it is (S30).

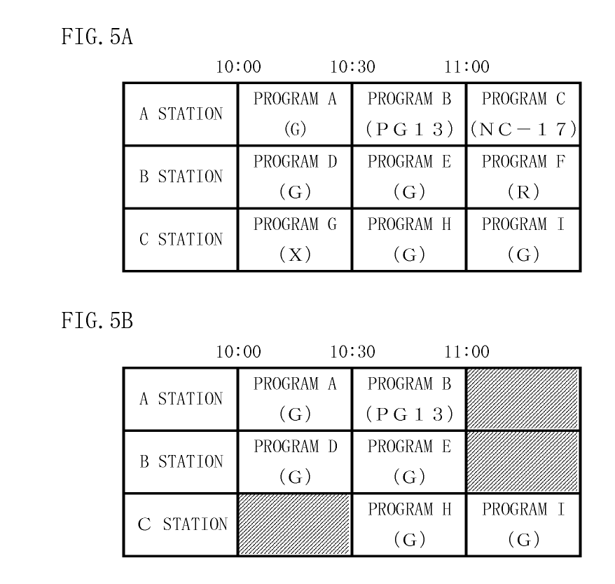

FIGS. 5A and 5B show an example of the displayed EPG. FIG. 5A shows the displayed EPG when the user whose rating data is Not Rated has input his/her own password. In the EPG, the titles and outlines of programs of the designated channels and time slots, and so on are displayed. The rating data of the user is Not Rated, so that the user can watch every program, and the program information and outlines of all programs are displayed in the EPG

FIG. 5B shows the displayed EPG when the user whose rating data is R watches the program alone. Also in this case, designated channels and time slots are same as those in FIG. 5A. The rating data of the user is R, so that the fields of the program whose parental level data is R and the program whose parental level data is NC-17 or X, which is in the lower level than R, are shown in gray, and the user cannot watch the program information.

Consequently, according to the TV receiver 1 of the present preferred embodiment, the rating data is stored for each user and the user watching the program is recognized by the password, so that the display of the program which is subject to the parental restriction in the EPG can be restricted in accordance with the user. Thus, the display of the harmful information provided by the written words in the program information displayed in EPG can be restricted in accordance with the user.

### Second Preferred Embodiment

Next, a TV receiver according to the second preferred embodiment of the present invention is described. A TV receiver of the present preferred embodiment differs from the TV receiver 1 of the first preferred embodiment 1 in a configuration of a rating data input unit and a user recognition unit. In the present preferred embodiment, a rating data input unit 8 and a user recognition unit 10 have a fingerprint recognition unit (not shown), and the user is not recognized by the password, but the fingerprint recognition. The fingerprint of each user is inputted from the fingerprint recognition unit in the rating data input unit 8 and stored in the memory 9 as the user data in advance. When watching the program, the user is recognized by the fingerprint recognition unit in the user recognition unit 10. The user is recognized by the fingerprint recognition, so that it is possible to restrict the display of the harmful information provided by the written words in the EPG more reliably and easily.

The present invention is not limited to the configuration of the above preferred embodiment, however, various modification are applicable within the scope of the invention. For example, the user can be recognized by reading a card having an ID (identification) data for each user. Moreover, the field of the program which is subject to the parental restriction in EPG can be displayed in white or black color, for example, instead of gray, as long as the program information of the parental restricted program is not shown.

What is claimed is:

1. A television receiver which receives television broadcast signals including a program information indicating contents of a program and a parental level data indicating a parental restriction together with an audio/video data to display Electronic Program Guide, comprising:
a receiving means which receives the television broadcast signals;
a separating means which separates the television broadcast signals received by the receiving means into the audio/video data, the program information, and the parental level data;
an audio/video decoder which decodes the audio/video data separated by the separating means;
an audio/video signal processing means which processes audio/video signals decoded by the audio/video decoder;
an audio/video outputting means which outputs audio and video based on the audio/video signals processed by the audio/video signal processing means;
a program related data decoder which decodes the program information and the parental level data separated by the separating means;
a rating data inputting means which inputs a rating data for each user;
a storage means which stores a rating data inputted by the rating data inputting means;
a user recognition means which recognizes a user watching the video and listening to the audio outputted by the audio/video outputting means;
and a microprocessor which controls respective units in the television receiver, wherein
the microprocessor performs a parental restriction of a program which is subject to the parental restriction and a display restriction of the program which is subject to the parental restriction in the EPG in accordance with the parental level data decoded by the program related data decoder and the rating data of the user recognized by the user recognition means.

2. The television receiver according to claim 1, wherein
the user recognition means recognizes the user by fingerprint recognition.
